(19) United States
(12) Patent Application Publication
(10) Pub. No.: US 2007/0234865 A1
(43) Pub. Date: Oct. 11, 2007

(54) Table Fence For A Miter Saw With Top Table

(76) Inventors: Pierluigi Spinelli, Perugia (IT); James R. Parks, White Hall, MD (US)

Correspondence Address: THE BLACK & DECKER CORPORATION, 701 EAST JOPPA ROAD, TW199, TOWSON, MD, 21286, US

(21) Appl. No.: 11/733,900

(22) Filed: Apr. 11, 2007

(30) Foreign Application Priority Data
Apr. 11, 2006 (GB) GB 06 072 75.5
Aug. 1, 2006 (GB) GB 06 152 44.1

(51) Int. Cl. B27B 27/06

(52) U.S. Cl. 83/471.3; 83/467.1

(57) ABSTRACT

A saw with a base assembly connected to a mounting portion; a motor unit which is pivotally mounted on the mounting portion to allow the motor unit to pivot towards or away from the base assembly to perform chop cuts, a table mounted on the motor unit to enable the saw to act as a table saw and a table fence capable of being releaseably attached to the table 114. The table fence comprises a guide plate, a guide fence moveably connected to the guide plate, and a locking mechanism for releaseably locking the position of the guide fence to the guide plate.

### FIELD

The present invention relates to saws, and in particular, to powered saws which can perform miter cuts, chops cuts, sliding cuts or bevel cuts, or any combination of these functions.

### BACKGROUND

WO98/18588 discloses a sliding compound miter saw. Such a saw can perform bevel cuts, miter cuts, sliding cuts and chop cuts. The sliding compound miter saw disclosed comprises a base 12 (using the same reference numbers as those used in WO98/18588) having a rotatable table 14 mounted within it. The rotatable table 14, in conjunction with a fence 26 fixed to the base 12, enables the sliding compound miter saw to perform miter cuts. Connected to the rear of the table 14 is a bevel mount 16 which is able to pivot about a horizontal axis in relation to the table 14. The pivotal movement of the bevel mount 16 in relation to the table 14 enables the sliding compound miter saw to perform bevel cuts. Slideably mounted onto the bevel mount 16 are two guide rods 34 which are capable of sliding horizontally, backwards and forwards. The rods 34 enable the sliding compound miter saw to perform sliding cuts. Pivotally mounted on the end of the guide rods 34 is a motor unit 36, which comprises a motor 22 for rotationally driving a circular saw blade 18 mounted on a drive spindle on the motor unit 36. The pivotal movement of the motor unit 36 in relation to the guide rods 34 enable the saw to perform chop cuts.

Rigidly mounted to the motor unit 36 is a fixed guard 40 which surrounds the cutting edge of the top half of the cutting blade 18. Pivotally mounted to the motor unit is a pivotal guard 42 which can pivot between a first position where it surrounds the cutting edge of the lower half of the cutting blade and a retracted position where the cutting edge of the lower half of the blade 18 is exposed for use in cutting.

The pivotal guard is pivoted between its two positions using a mechanical linkage which comprises a series of mechanical arms 48, 50, which are pivotally connected to each other and the saw, and cams 52, 54 which control the movement of the arms 48, 50. As the motor unit is pivoted downwards, the mechanical linkage causes the lower cutting edge of the blade to become exposed due to the retraction of the pivotal guard by the mechanical linkage.

JP2005-178281 describes a chop saw with a table mounted on top of the motor unit. The table enables the saw to be used as a table saw.

Table saws typically comprise a table fence which help an operator to guide work pieces across the table in a linear direction.

### SUMMARY

There is provided a saw comprising a base assembly connected to a mounting portion, a motor unit which is pivotally mounted on the mounting portion to allow the motor unit to pivot towards or away from the base assembly to perform chop cuts; and/or slidingly connected to the mounting portion to allow the motor unit to slide across the base assembly to perform sliding cuts the motor unit having an output drive spindle upon which a circular saw blade can be rigidly mounted to be rotationally driven by the motor unit, a table mounted on the motor unit to enable the saw to act as a table saw and a table fence capable of being releaseably attached to the table, the table fence comprising a guide plate, a guide fence moveably connected to the guide plate, and a locking mechanism which can releaseably lock the position of the guide fence to the guide plate wherein, when the locking mechanism is activated, the guide fence is held rigidly relative to the guide plate and when it is released, it allows relative movement between the guide plate and the guide fence so that both the position and the orientation of the guide fence relative to the guide plate can be altered.

Also provided is a table fence comprising a guide plate, a guide fence moveably connected to the guide plate, and a locking mechanism which can releaseably lock the position of the guide fence to the guide plate wherein, when the locking mechanism is activated, the guide fence is held rigidly relative to the guide plate and when it is released, it allows relative movement between the guide plate and the guide fence so that both the position and the orientation of the guide fence relative to the guide plate can be altered.

In addition a saw may have a base assembly connected to a mounting portion, a motor unit which is pivotally mounted on the mounting portion to allow the motor unit to pivot towards or away from the base assembly to perform chop cuts; and/or slidingly connected to the mounting portion to allow the motor unit to slide across the base assembly to perform sliding cuts, the motor unit having an output drive spindle upon which a circular saw blade can be rigidly mounted to be rotationally driven by the motor unit, wherein there is further provided a table mounted on the motor unit to enable the saw to act as a table saw and a table fence capable of being releaseably attached to the table, characterised in that the table fence comprises a cam mechanism moveable between two positions, a first position where it frictionally holds onto a part of the table and a second position where it is disengaged from the table.

Also described is a table fence for a saw comprising a base assembly connected to a mounting portion, a motor unit which is pivotally mounted on the mounting portion to allow the motor unit to pivot towards or away from the base assembly to perform chop cuts, and/or slidingly connected to the mounting portion to allow the motor unit to slide across the base assembly to perform sliding cuts the motor unit having an output drive spindle upon which a circular saw blade can be rigidly mounted to be rotationally driven by the motor unit, and a table mounted on the motor unit to enable the saw to act as a table saw, wherein the table fence is capable of being releaseably attached to the table of such a saw, characterised in that the table fence comprises a cam mechanism moveable between two positions, a first position where it is capable of frictionally holding onto a part of a table of such a saw and a second position where it is not capable of frictionally holding onto that part of a table of such a saw.

### DESCRIPTION OF THE DRAWINGS

An embodiment of the present invention will now be described with reference to the accompanying drawings of which:

FIG. 1 shows a sliding compound miter saw with a table from a first perspective;

FIG. 2 shows a sliding compound miter saw with a table from a second perspective;

FIGS. 3A to 3I show the table fence of the first embodiment of the table fence of which.

FIG. 3A is a top downward looking view;

FIG. 38 is a front view in the directions of Arrows Q in FIG. 3A:

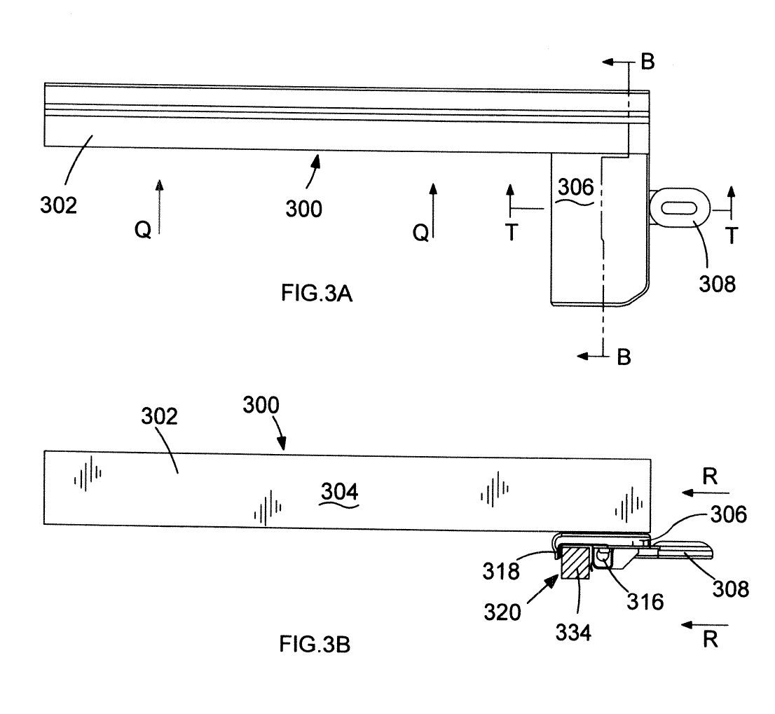

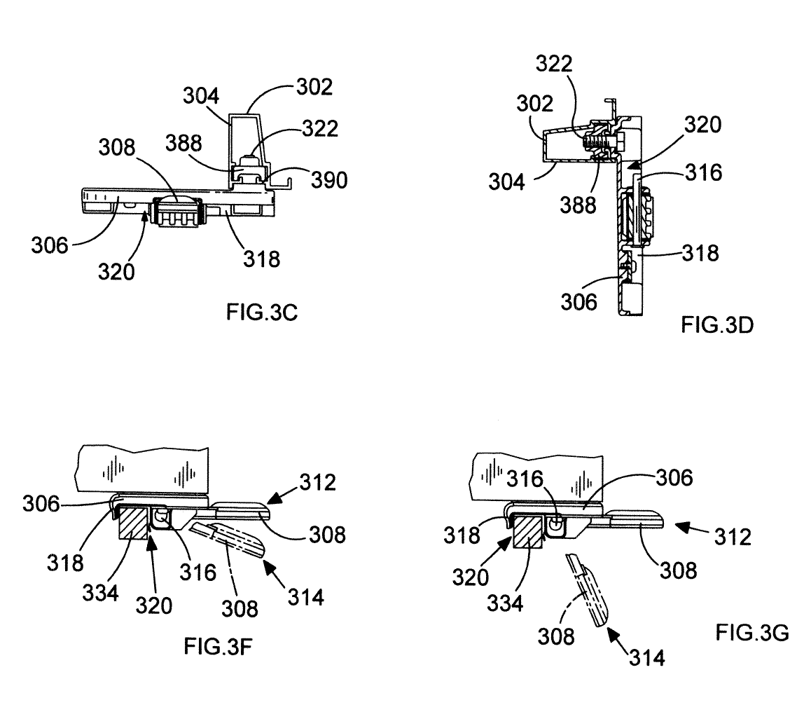

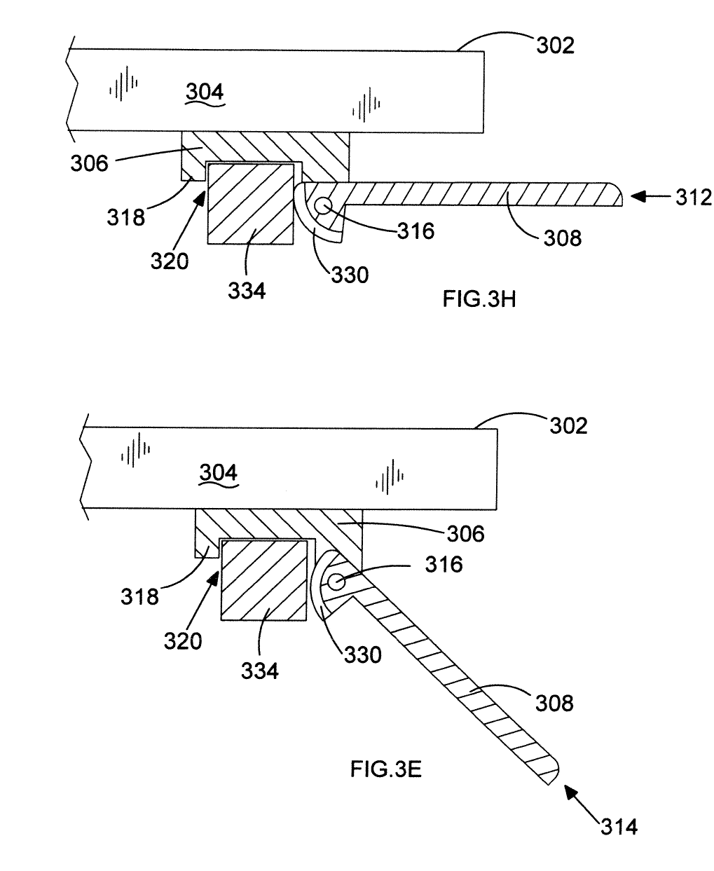

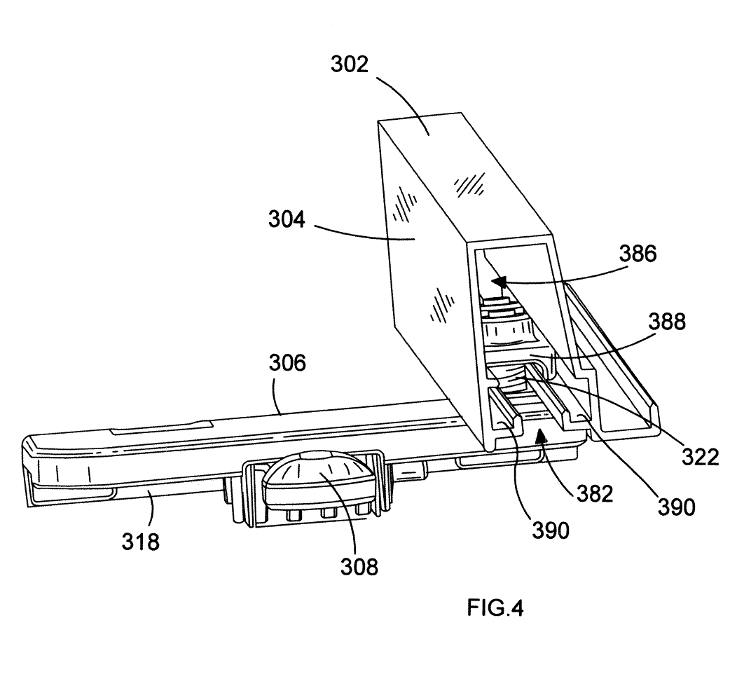

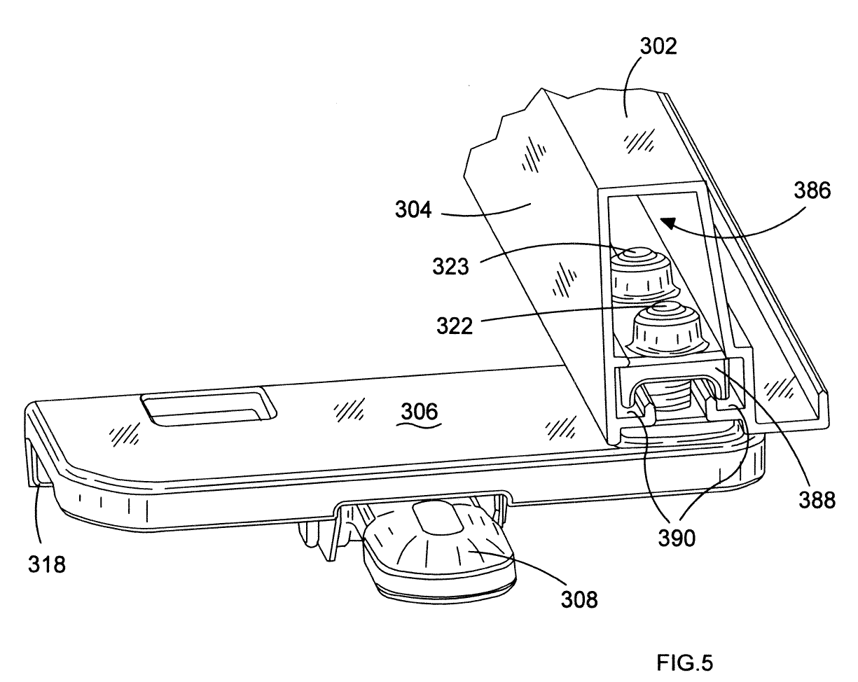

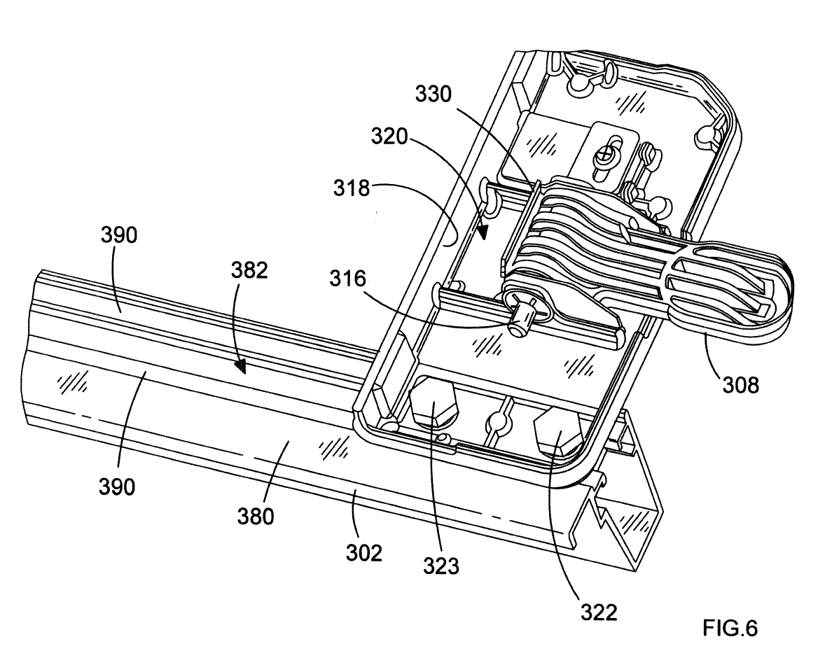

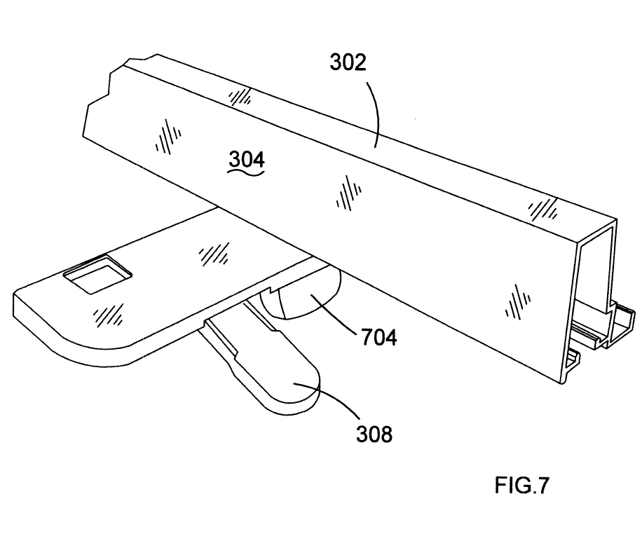

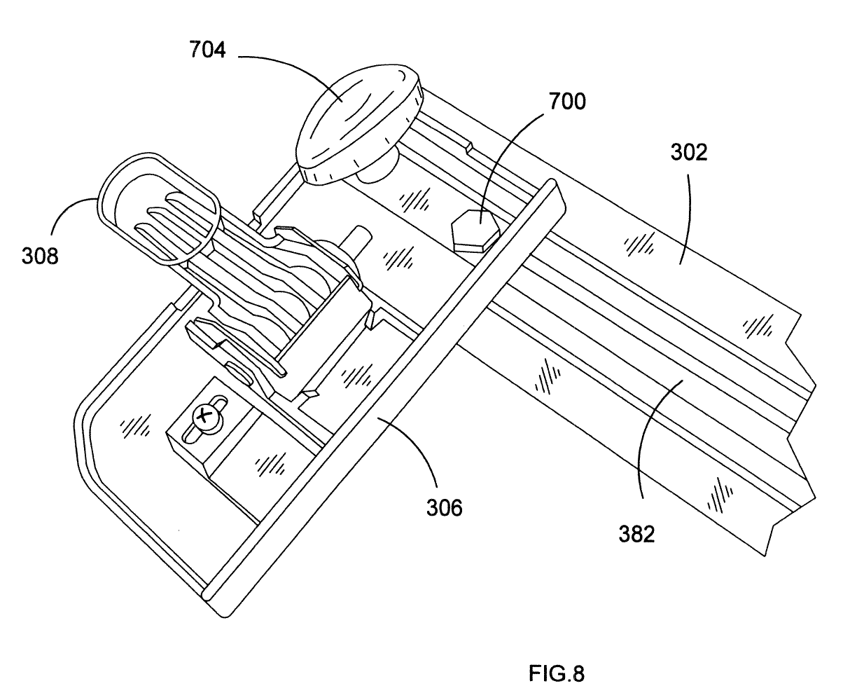

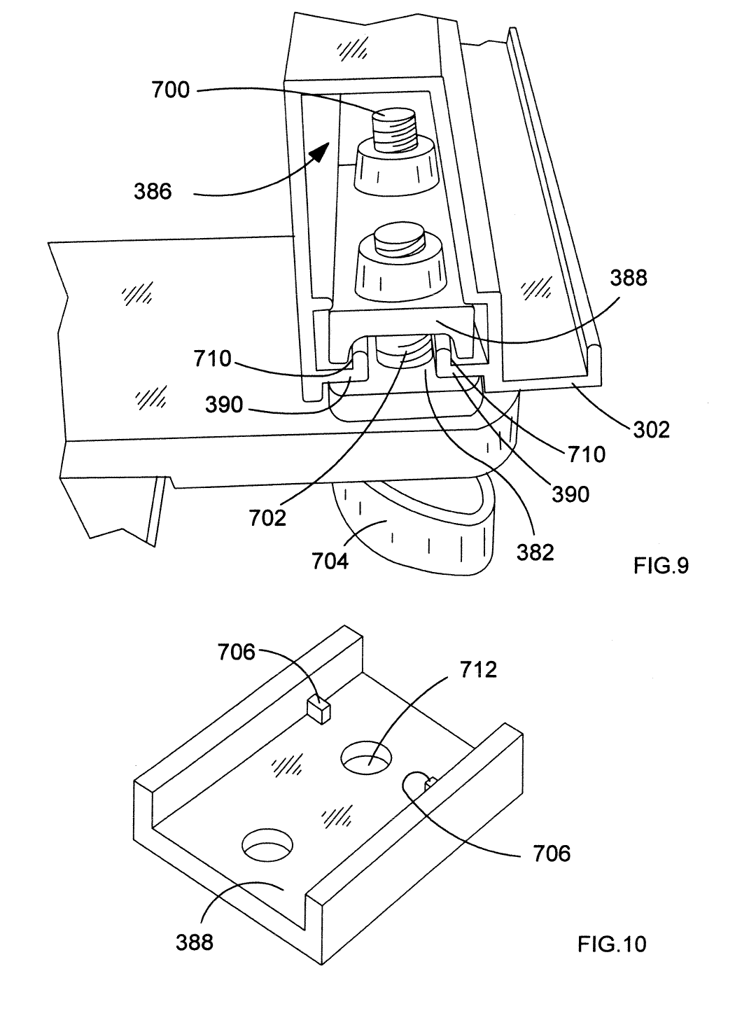

FIG. 3C is an end view in the direction of Arrows R in FIG. 3B;

FIG. 3D is a vertical cross sectional view along the line indicated by Arrows B in FIG. 3A;

FIG. 3E is a vertical cross section of the table fence in the direction of Arrows T in Figure A with the latch lever in a second position;

FIGS. 3F and 3G are front views with the latch lever in different positions; and

FIG. 3H is a vertical cross section of the table fence in the direction of Arrows T in Figure A with the latch lever in a first position;

FIG. 4 shows a rear perspective view of the table fence 300 with the guide fence in a first position;

FIG. 5 shows a rear perspective view of the table fence 300 with the guide fence in a second position;

FIG. 6 shows the underside of the table fence, and

FIG. 7 shows a perspective view of the table fence of the second embodiment of the table fence;

FIG. 8 shows an underside view of the table fence of the second embodiment of the table fence;

FIG. 9 shows a rear perspective view of part of the table fence of the second embodiment of the table fence; and

FIG. 10 shows an underside view of the cast of the second embodiment of the second embodiment of the table fence.

### DETAILED DESCRIPTION

The embodiments described herein relate to a sliding compound miter saw, similar to that described in WO98/18588, which has a table mounted on top of the motor unit to enable the saw to act as a table saw.

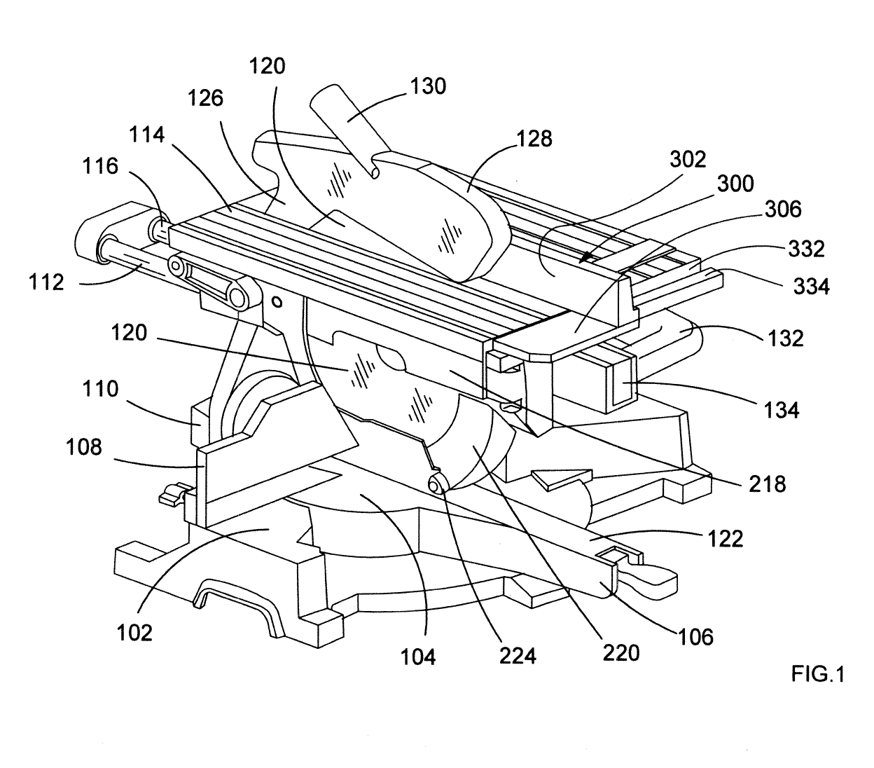

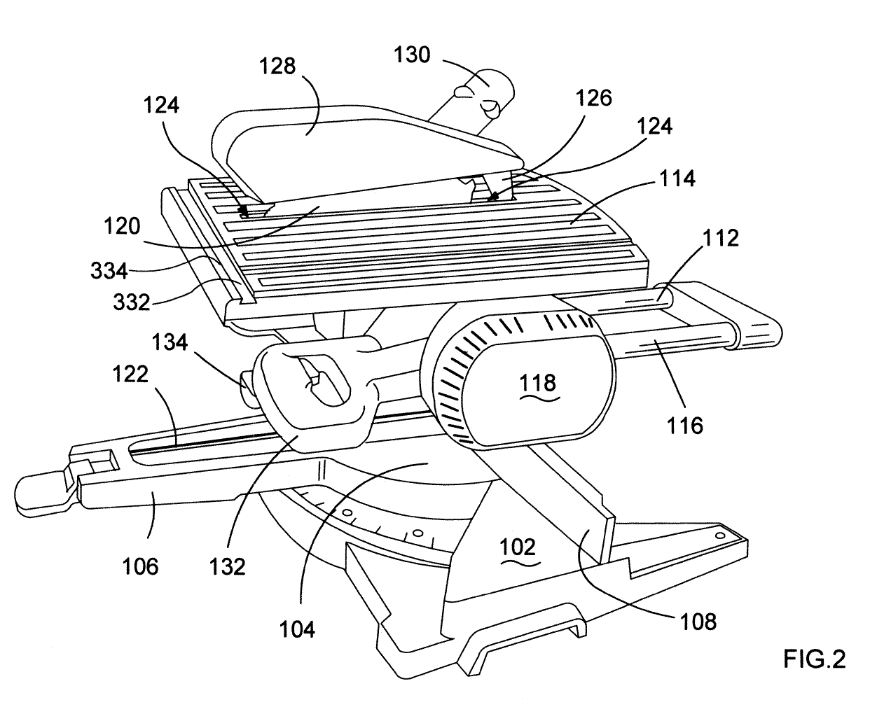

A first embodiment of the table fence will now be described with reference to FIGS. 1 to 6. Referring to FIGS. 1 and 2, there is provided a sliding compound miter saw with a table 114 which can perform bevel cuts, miter cuts, sliding cuts and chop cuts. The saw comprises a base having a rotatable table 104 mounted within it. An extension arm 106 is preferably attached to the periphery of the rotatable table 104 and extends forward in well known manner. The rotatable table 104, in conjunction with a fence 108 fixed to the base 102, enables the saw to perform miter cuts. A bevel mount 110 is preferably connected to the rear of the rotatable table 104, and is able to pivot about a horizontal axis in relation to the rotatable table 104. The pivotal movement of the bevel mount 110 in relation to the rotatable table 14 enables the saw to perform bevel cuts. Two guide rods 112, 116 may be slideably mounted onto the bevel mount 110, and are capable of sliding horizontally, backwards and forwards. The rods 112, 116 enable the saw to perform sliding cuts. A motor unit 118, may be pivotally mounted on the end of the guide rods 112, 116. Motor unit 118 may comprise a motor (not shown) for rotationally driving a circular saw blade 120 mounted on a drive spindle on the motor unit 118. The pivotal movement of the motor unit 118 in relation to the guide rods 112, 116 enable the saw to perform chop cuts. The motor unit 118 is preferably biased to an upward position by a spring (not shown). A slot 122 may extend across the rotatable table 104 and along the extension arm 106.

Mounted on the top of the saw is a table 114 which enables the saw to be also used as a table saw. The table 114 is preferably attached to the top side of the motor unit 118. A slot 124 may be formed through the table 114 through which the top section of the circular saw blade 120 projects. The motor unit 118 can be locked in a downward position such that the table 114 is horizontal. A work piece, such as a piece of wood, can then be slid across the top of the table 114 to engage with the top section of the saw blade 120 thus enabling the saw to be used as a saw table. A riving knife 126 may be located towards the rear of the saw blade 120 and a guard 128 can surround the top of the saw blade 120 when the saw is not being used as a table saw, which includes a shoot 130 for the extraction of wood chips.

The saw preferably comprises a plurality of guards located below the table 114 which are capable of enclosing the lower section of the saw blade for safety purposes when the saw is not being used for performing chop, miter, bevel or sliding cuts, for example, when the saw is being used as a table saw, with the motor unit 118 locked downwardly.

A handle 132 may be attached to the motor unit 118 by which a user can grip and pivot the motor unit 118 and the circular saw blade 120 downwards towards the rotatable table 104. An electric switch 134 is preferably mounted on the handle 132 for activating the motor.

The motor unit 118 can be locked in its lowest pivotal position against the biasing force of the spring. When the motor unit 118 is in this position, the table 114 is horizontal. In this position the table 114 can be used as a table saw, the work piece 216 being cut by the part of the saw blade 120 which passes through the slot 124.

When the motor unit 118 is free to pivot, the saw can be used as a sliding compound miter saw.

The height of the table 114, and hence the amount of saw blade 120 passing through it, can be adjusted vertically.

Referring to FIGS. 3A to 3G, 4, 5 and 6 there is provided a table fence 300 for use with the table 114.

The table fence is used by an operator to guide work pieces across the table 114 when the saw is being used as a table saw. It is important that the movement of a work piece, when it is being cut, is linear and that its direction is parallel to the plane of the blade. This to ensure a smooth cuffing action. A table fence is therefore provided. The operator slides the work piece along a straight side of the table fence 300, the straight side being aligned with the plane of the blade 120.

The table fence 300 preferably comprise a guide fence 302. The guide fence 302 may have an elongate tubular structure having a substantially uniform cross-section along its length. A flat vertical face 304 may be formed on one side along the length of the fence guide 302. In use, a work piece is slid along this surface 304.

A guide plate 306 is preferably attached to the guide fence 302, at one end of the guide fence 302, via two bolts 322, 323. Details of the connection between the guide fence 302 and the guide plate 306 is provided below.

A latch lever 308 may be pivotally mounted on the guide plate 306. The latch lever 308 can pivot from a first position 312 where it is horizontal (see FIG. 3H), extending in the same direction as the guide fence 302 to a second downward position 314 (see FIG. 3E). The latch lever 308 may be pivotally mounted on a pin 316 mounted on the underside of the guide plate 306 (see FIG. 6), A lip 318 is preferably formed along the length of the guide plate. The end of the lever 308 adjacent the pin 316 faces the lip 318. This results in a channel 320 being formed between the two.

The end of the latch lever 308 adjacent the pin 316, may be shaped so that it forms a cam 330. The cam 330 is preferably shaped so that, when the latch lever 308 is in its first position 312 (FIG. 3H), the cam 330 reduces the width of the channel 320, but when the latch lever 308 is in its second position 314 (FIG. 3E), the width of the channel 320 is increased.

A groove 332 may be formed across the front of the table 114 (see FIGS. 1 and 2). The groove 332 results in a ridge 334 of approximately square cross section being formed along the front edge of the table 114. When the table fence 330 is located on the table 114, the ridge 334 of the table 114 preferably locates within the channel 320 of the table fence 300. (In FIG. 3A to 3H, for simplicity of the drawings, the ridge 334 is simply shown as a square block. However, it is preferably integrally formed with the table 114 as shown in FIGS. 1 and 2.) The guide fence 302 may extend generally in a forward/rearward direction, parallel to the plane of the blade 120. However, its precise alignment relative to the blade 120 can be altered, as described below.

In order to mount the table fence 300 onto the table 114, the latch lever 308 is preferably moved to its second position 314 so that the cam 330 is located outside of the channel 320. The table fence 300 is placed on the table 114 so that the ridge 334 locates within the channel 320. The latch lever 308 preferably extends forward beyond the front edge of the table 114. This ensures that the table 114 does not interfere with the pivotal movement of the latch lever 308. The latch lever 308 is then pivoted to its first position 312 so that the width of the channel 320 is reduced causing the cam 330 to frictionally engage with the side of the ridge 334, sandwiching it between the cam 330 and the lip 318. The shape of the cam 330 is such that it locks the table fence 300 to the ridge 334. An operator can then use the vertical surface 304 of the guide fence 302 to guide a work piece in a straight direction into the cutting blade, the work piece sliding along the vertical surface 304 in a direction parallel to the plane of the blade 120.

In order to release the guide fence 302 from the table 114, the operator pivots the latch lever 308 from its first position 312 to its second position 314, moving the cam 330, increasing the width of the channel 320, disengaging it from the ridge 334. The table fence 300 can then be removed from the table 114.

The position of the guide fence 302 from the cutting blade 120 can be adjusted. The latch lever 308 is pivoted to its second position, disengaging the cam 330 from the ridge 334. The guide fence 302 is then slid towards or away from the cutting blade 120. This results in the ridge 334 sliding within the channel 320, until the desired position is reached. The latch lever 308 is then pivoted to its first position 312, engaging with the ridge 334 and sandwiching it between the cam 330 and the lip 318 to lock the position of the guide fence 302 relative to the table 114.

The shape of the cam 330 is such that when the latch lever 308 is in its first position 312, it is held there by the frictional engagement of the cam 330 with the ridge 334.

The position of the guide fence 302 can be adjusted relative to the guide plate 306. The connection between the two will now be described in more detail.

The guide fence 302 may comprise a tubular aperture 386 which runs through the full length of the guide fence. A slot 382 is preferably formed along the length of the lower surface 380 of the guide fence 302 which faces the guide plate 306. The slot 382 provides a passageway into the tubular aperture 386. A metal cast 388 may be located within the tubular aperture 386, the dimensions of which are too large to permit it from passing through the slot 382. Two threaded holes are preferably formed in the cast 388.

Two holes are preferably formed through the guide plate 306. The shafts of the two bolts 323, 322 pass through the holes in the guide plate 306 and threadingly engage with the two threaded holes in the cast 388. The head of the bolts 322, 323, as seen in FIG. 6, are too large to pass through the holes in the guide plate 306. When the bolts are tightened, they move the cast 388 towards the guide plate 306, sandwiching the edges 390 of the guide fence 302 which form the edges of the slot 382 between guide plate 306 and the cast 388. Once the bolts are tightened, the guide fence 302 is rigidly attached to the guide plate 306. If the bolts are slackened, the position of the guide fence 302 can be moved relative to the guide plate 306. The guide fence 302 can slide along its longitudinal axis, as the shafts of the bolts slide along the slot 382. FIG. 4 shows the guide fence 302 in a first position, FIG. 5 shows it in a second position.

The width of the slot 382 is preferably greater than the width of the shaft of the bolts 322, 323. Therefore, when the bolts 322, 323 are slackened, the guide fence can also be moved angularly relative to the guide plate 306 to adjust the orientation of the guide fence 302 relative to the guide plate 306. This allows the guide fence to be accurately aligned relative to the plane of the cutting blade 120.

Once the orientation has been adjusted so that accurate alignment has been made and the correct relative position selected, the bolts 322, 323 can be tightened to hold the position of the guide fence 302 relative to the guide plate 306.

A second embodiment of the table fence will now be described with reference to FIGS. 7 to 10. The second embodiment is the same as the first embodiment except for the design of the bolts 322, 323 and the cast 388. Where the same features occur in the second embodiment, the same reference numbers have been used.

The first embodiment of the table fence used two bolts 322, 323 which clamped the guide fence 302 to the guide plate 306. In the second embodiment, the two bolts 322, 323 have been replaced with one regular bolt 700 and a bolt 702 having a wing grip 704. The regular bolt 700 is used for stability; during normal use it doesn't get tightened completely. The amount by which the bolt 700 is screwed into the cast 388 is set so that the guide fence 302 beam can slide freely and can be angled relative to the guide plate 306 without being too loose to set its alignment and position relative to the blade 120. Then when the second bolt 702 is tightened using the wing grip 704 to lock the guide fence 302 securely. Such a design enables the position of the guide fence to be set manually as the regular bolt 700 does not have to be adjusted during normal use of the table fence, only the bolt 702 with the wing grip 704.

Two protrusions 706 are formed on the underside of the cast 388 near aperture 712 through which the regular bolt 700 passes. These protrusions 706 engage with the sides 710 of the edges 390 of the guide fence 302. This prevents sideways movement of the guide fence 302 on the cast 388 at the position of the aperture 712 through which the regular bolt 700 passes. As such, the cast guide fence 302 is prevented sliding side ways relative to the cast 388 at the position of the aperture 712 along the length of the cast 388. As such, the pivotal movement of the guide fence 302 on the cast 388 is about the aperture 712 for the regular bolt, the side to side slop of the guide fence 302 being restricted by the bolt 702 with the wing grip 704.

As such, when the bolt 702 with the wing grip 704 is unscrewed to loosen the guide fence 302, the guide fence 302 can either pivot around these protrusions 706, or slide along them, and can then be locked securely by the bolt 702 with the wing grip 704 being tightened.

1. A saw comprising:
a base assembly connected to a mounting portion;
a motor unit pivotally mounted on the mounting portion to allow the motor unit to pivot towards or away from the base assembly to perform chop cuts;
the motor unit having an output drive spindle for rotationally driving a circular saw blade;
a table mounted on the motor unit;
a table fence being releaseably attached to the table, the table fence comprising a guide plate, a guide fence moveably connected to the guide plate, and a locking mechanism for releaseably locking the position of the guide fence to the guide plate wherein, when the locking mechanism is activated, the guide fence is held rigidly relative to the guide plate and when it is released, it allows relative movement between the guide plate and the guide fence so that both the position and the orientation of the guide fence relative to the guide plate can be altered.

2. A saw as claimed in claim 1 wherein the locking mechanism comprises at least one bolt which passes through both the guide plate and the guide fence so that at least part of the guide plate and at least part of the guide fence are sandwiched between the ends of the at least one bolt, and which at least one bolt is arranged so that when the bolt is tightened, the guide fence is held rigidly relative to the guide plate but when slackened, both the position and the orientation of the guide fence relative to the guide plate can be altered.

3. A saw as claimed in claim 2 wherein the guide fence comprises a slot which runs along at least a part of the length of the guide fence through which the at least one bolt passes, the at least one bolt being able to slide along the slot to allow the position of the guide fence to be altered relative to the guide plate when the bolt is slackened.

4. A saw as claimed in claim 3 wherein the width of the slot is greater than the width of the shaft of the at least one bolt so that the at least one bolt can traverse the width of the slot to allow the orientation of the guide fence altered relative to the guide plate when the at least one bolt is slackened.

5. A saw as claimed in claim 3 wherein the guide fence has a tubular constructions the slot forming a passageway through the wall of the guide fence.

6. A saw as claimed in claim 5 wherein one end of the at least one bolt is screwed in a cast located within the guide fence.

7. A table fence comprising:
a guide plate;
a guide fence moveably connected to the guide plate; and
a locking mechanism for releaseably locking the position of the guide fence to the guide plate wherein, when the locking mechanism is activated, the guide fence is held rigidly relative to the guide plate and when it is released, it allows relative movement between the guide plate and the guide fence so that both the position and the orientation of the guide fence relative to the guide plate can be altered.

8. A table fence as claimed in claim 7 wherein the locking mechanism comprises at least one bolt which passes through both the guide plate and the guide fence so that at least part of the guide plate and at least part of the guide fence are sandwiched between the ends of the at least one bolt, and which at least one bolt is arranged so that when the bolt is tightened, the guide fence is held rigidly relative to the guide plate but when slackened, both the position and the orientation of the guide fence relative to the guide plate can be altered.

9. A table fence as claimed in claim 8 wherein the guide fence comprises a slot which runs along at least a part of the length of the guide fence through which the at least one bolt passes, the at least one bolt being able to slide along the slot to allow the position of the guide fence to be altered relative to the guide plate when the bolt is slackened.

10. A table fence as claimed in claim 9 wherein the width of the slot is greater than the width of the shaft of the at least one bolt so that the at least one bolt can traverse the width of the slot to allow the orientation of the guide fence altered relative to the guide plate when the at least one bolt is slackened.

11. A table fence as claimed in claim 9 wherein the guide fence has a tubular construction, the slot forming a passageway through the wall of the guide fence.

12. A saw comprising:
a base assembly connected to a mounting portion;
a motor unit pivotally mounted on the mounting portion to allow the motor unit to pivot towards or away from the base assembly to perform chop cuts;
the motor unit having an output drive spindle for rotationally driving a circular saw blade;
a table mounted on the motor unit to enable the saw to act as a table saw and a table fence being releaseably attached to the table;
the table fence comprising a cam mechanism moveable between two positions, a first position where it frictionally holds onto a part of the table and a second position where it is disengaged from the table.

13. A saw as claimed in claim 12 wherein the table fence comprises a channel which is capable of receiving a part of the table wherein, when that part is located within the channel, the cam mechanism, when it is in its first position, sandwiches a part of the table located within the channel against a wall of the channel in order to frictionally hold onto that part of the table, and when it is in its second position, it is disengaged from the part of table located in the channel, allowing that part of table within the channel to freely move within the channel.

14. A saw as claimed in claim 13 wherein the table comprises a ridge for locating within the channel.

15. A saw as claimed in claim 14 wherein the ridge is substantially straight and is located across the front of the table.
